(19) United States
(12) Patent Application Publication
(10) Pub. No.: US 2007/0294068 A1
(43) Pub. Date: Dec. 20, 2007

(54) LINE-WALKING RECURSIVE PARTITIONING METHOD FOR EVALUATING MOLECULAR INTERACTIONS AND QUESTIONS RELATING TO TEST OBJECTS

(76) Inventors: Jeffrey P. Jones, Pullman, WA (US); Matthew G. Hudelson, Kendrick, ID (US)

Correspondence Address: DAVIS WRIGHT TREMAINE, LLP, 1201 Third Avenue, Suite 2200, SEATTLE, WA, 98101-3045, US

(21) Appl. No.: 11/753,430

(22) Filed: May 24, 2007

Related U.S. Application Data
(60) Provisional application No. 60/808,314, filed on May 24, 2006.

(51) Int. Cl. G06F 19/00

(52) U.S. Cl. 703/11; 703/12

(57) ABSTRACT

Particular aspects provide line-walking recursive partitioning (LWRP) methods for evaluating molecular interactions (e.g., enzyme-substrate binding/interaction, protein-protein interaction/docking, protein-small molecule and protein-nucleotide interactions, molecule-molecule and surface-molecule interactions, protein activity inhibition or activation based on a molecular interaction/binding event, or modulation or inhibition of P450 drug metabolism). A training set serves as a collection of molecular points in m-dimensional space, each dimension corresponding to a chemical descriptor, each point having a molecule-descriptor value. In this geometric setting, dissection of the space into regions is decided according to LWRP-generated hyperplanes; a novel ‘line-walking algorithm’ is used to generate optimal hyperplanes for recursive partitioning. Preferably, such line-walking embodiments additionally comprise use of a small or reduced number of descriptors relative to prior art methods. The results are relatively easily evaluated, and applicable to molecules outside of the ‘training set.’ Additional aspects provide LWRP methods for predicting a numerical value (e.g., pKi) or a molecule.

### CROSS-REFERENCE TO RELATED APPLICATIONS

This application claims the benefit of priority to U.S. Provisional Patent Application Ser. No. 60/808,314, filed May 24, 2006, which is incorporated herein by reference in its entirety.

### STATEMENT REGARDING FEDERALLY-SPONSORED RESEARCH

Certain aspects of this work were supported by grant # 09122 from the National Institute of Environmental Health Sciences.

### FIELD OF EXEMPLARY ASPECTS

Particular aspects relate generally to methods for event prediction that can be applied to a range of decisions, including but not limited to facilitating drug design by evaluating the likelihood of molecule-molecule interactions, and in more particular exemplary aspects to computer implemented methods for evaluating and/or predicting enzyme-substrate interaction, reactivity and binding, including but not limited to predicting the likelihood of a substrate binding to a particular enzyme or class of enzymes, and to drug design. Additional exemplary implementations include application to regioselective reactivity (e.g., reactivity of particular sites or atomic positions of a molecular structure, such as a ring structure or radical moiety, application to stock purchase decisions or investment allocation decisions, application for insurance risk assessment, applications for medical treatment decisions, etc.).

### BACKGROUND

Predictive tools that enable an artisan to utilize sets of data points (e.g. “training set”), with respect to which the presence (or absence) of an event has been empirically determined, and that provide an accurate prediction of the presence (or absence) of an event for a data point that is outside the training set are of great value to practitioners in many technical areas.

Drug design tools are becoming more important as the pharmacological targets for therapy become more complicated. While abilities to develop a lead compound for a target have become better, attendant toxicities and chemical disposition ultimately determine if the compound can be used a drug. The better the drug-like properties of a series of compounds, the more likely a compound in the series is to survive clinical trials and become a successful drug. With the ever increasing cost of drug development, these properties become a make or break issue in the success of any given compound. It has been estimated that approximately 70% of new chemicals entering preclinical development are removed from the pipeline as a result of poor disposition or toxicities².

For a drug to be successful it must meet a number of criteria which are outlined below. While a drug with less than ideal characteristics can be brought to the market, fast followers from other companies will erode profits, and hence new discovery funding. Therefore, early attention to making a good drug will lead to a better overall first generation drug with a better opportunity to recover development costs.

Ideally, to assure patient compliance, daily dosing is desirable. The compound also must also be bioavailable and get to the site of action. A drug must have low toxicity, which in some instances can result from target toxicity, or bioactivation to a reactive species. Preferably, drugs should have multiple metabolic pathways to lower the potential for drug-drug interactions and drug-xenobiotic interactions. Additionally, having a high affinity for the target is important in decreasing toxicity, and drug-drug interactions. Of these criteria, often only high target specificity is used in early discovery.

A potentially more successful approach is to balance target affinity, and the other characteristics that make a chemical a drug. Thus, tools for early screening of large numbers of molecules for drug-like properties as well as pharmacological activity are very important. An excellent example of this approach is the concurrent prediction of hERG K⁺ channels, a pharmacological target, and P450 2D6 inhibition properties by O'Brien and de Groot³.

While design tools for pharmacological targets need to predict affinities for a single target site, predicting bioactivation, metabolic profiles, and bioavailability needs to take into account multiple active sites, and reactivities. A number of groups have developed local models for predicting affinities, or reactivities of the individual enzymes responsible for drug metabolism⁴⁻⁶, and bioavailability⁷ that function very well. The metabolism models assume that a compound is a substrate for the enzyme, and that it is related to members of the training set. Thus, a rapid robust model for segregating chemicals into local space becomes important.

Some efforts in filtering chemicals to predict the enzymes responsible for metabolism have recently been published^{1,8-11}. One of the first applications of a method to predict metabolic enzymes was presented by Susnow and Dixon⁹. A reportedly diverse ‘training set’ of 100 compounds was used to train a recursive partitioning model to determine if a compound would bind to CYP2D6 with an affinity lower or higher than 10 μM. This model used 25 ‘descriptors’ and was able to predict if a molecule from an external training set of 51 was an inhibitor with an impressive 80% accuracy.

Around the same time Ekins and coworkers presented a recursive partitioning model for predicting if a compound was a substrate for CYP3A4 or CYP2D6.¹¹ This model used a large training set of over 1759 CYP3A4 substrates and 1759 CYP2D6 substrates. The recursive partitioning models were built with 2500 descriptors, and a forest of 20 trees. These models did a reasonable job of predicting rank order affinities for an external ‘validation set’ of 98 molecules.

Sorich et al., have compared support vector machines to artificial neural networks, and partial least squares discrimination analysis⁸ in their ability to determine if compound are substrates for 12 isoforms of UDP-glucuronosyltransferase. They concluded that the support vector machines gave the best results based on the percent predictability for each enzyme using an optimized subset of 67 descriptors and distinct training sets for each of the 12 isoforms of UDP-glucuronosyltransferase that ranged in size from 151 to 38 compounds. The support vector machines were able to predict substrates from an external validation set 30% the size of the training set with between 63 and 88% accuracy, with the majority of predictions being over 75%.

Therefore, recursive partitioning holds promise for filtering molecules to determine if a given molecule will be, for example, an inhibitor or substrate for a given metabolic enzyme. Recursive partitioning involves the construction of a decision tree, or forest of trees, based on a training set. Descriptors are used to partition molecules into sets which have a bias towards a given property, such as inhibition. The partitioning is continued to generate increasingly more pure groups of molecules (e.g., inhibitors or noninhibitors).

One problem that appears, however, when attempting to predict properties for new compounds is that newer drugs in general are more metabolically stable, or occupy a different ‘chemical space’ than the training set of available drugs. Given this, a model for new drugs needs to be robust enough to predict outside of the chemical space of the training set. Prior art methods developed for predicting drug metabolism make an attempt to optimize their ability to predict the training set. Typically, however, this leads to using a large set of descriptors to optimally define the model. Unfortunately, the use of a large number of descriptors has a number of significant deleterious effects on the usefulness of the subsequent model. For example, the more descriptors that are used, the less likely a model will be to be able to predict outside of the chemical space it is trained. Additionally, models with a large number of descriptors are difficult to interpret, resulting in a low/reduced ability to visualize the changes required to re-design a chemical to have the desired properties.

There is, therefore, a pronounced need for novel, robust and effective methods having a reduced set/number of defining descriptors, so that such methods: are easy to interpret; allow predicting outside of the ‘training set’.

### SUMMARY OF EXEMPLARY ASPECTS

Aspects of the present invention provide a recursive partitioning method for evaluating the outcome of an event of interest. The method can be applied in any scenario where a training set is given as a database of descriptor values and where one needs to predict a binary (yes/no) activity of some other object that shares the descriptors used to describe the training set. While the specification and examples provided herein are largely directed toward the evaluation of molecular binding, it is to be understood that the recursive partitioning method described herein may be applied to any number of chemical, physical, financial and/or medical decisions. Example applications include, but are not limited to, enzyme-substrate binding, the prediction of labile sites on a molecule, the decision to purchase a stock, risk assessment for insurance, evaluation of a medical decision and a tool for assessing a process viability. Preferred exemplary embodiments provide a predictive method for use in drug design, however it is to be understood that predictive methods have many potential applications within a diverse set of areas as illustrated by the Examples herein.

Aspects of the present invention provide a recursive partitioning method for evaluating a test molecule for a molecular interaction, comprising: establishing a set of molecular descriptors relevant for evaluating a molecular interaction, the number of descriptors in the set equal to m; establishing a training set of molecules, each molecule having a known interaction response for the molecular interaction, and wherein the training set comprises at least one member demonstrating the molecular interaction and at least one member not demonstrating the molecular interaction; evaluating, for each descriptor, each molecule in the training set to provide a respective set of numerical descriptor-molecule values for each descriptor; mapping each molecule in the training set to respective column vectors by either: normalizing the respective descriptor values of each molecule by scaling and translation; or by assigning, within each respective set of descriptor-molecule values and based on the relative magnitude of the descriptor-molecule values, a descriptor-molecule rank value for each molecule to provide a respective ranked set of molecules for each descriptor and centering the rank values (e.g., at zero), wherein each molecule is mapped into m-dimensional space as the respective column vector to provide an m-dimensional space comprising a training set of column vectors; and recursively partitioning the training set of column vectors (i.e., the molecules of the m-dimensional space) according to splitting hyperplanes (that incorporate information from all descriptors simultaneously) that are generated according to a novel line walking algorithm (LWRP) as described herein, to provide for a decision tree having interior nodes corresponding to LWRP selected hyperplanes, the tree suitable for evaluating a test molecule for a molecular interaction. Preferably, the number of descriptors m is a number in a range of about 5 to about 20, about 7 to about 15, about 8 to about 12, about 9 to about 11, 9 to 11, or 9 to 10. More preferably, the number of descriptors m is 9 or 10.

Additional embodiments further comprise: selecting a test molecule; determining a test ranking vector (ranking column vector) for the test molecule by assigning, with respect to each descriptor, a test rank value to the test molecule, wherein the assigned test rank value: is that of a training set molecule having a matching descriptor-molecule value; is a test rank value that is a mean rank value where the test descriptor-molecule value lies between those of two training set molecules; is a rank that is one rank higher than the maximum rank of the training set; or is one rank lower than the minimum rank of the training set, to provide for a test ranking vector mapped within the m-dimensional array; and evaluating the test molecule (test ranking vector) by application of the decision tree having interior nodes corresponding to LWRP-selected hyperplanes, wherein evaluating a test molecule for the molecular interaction is, at least in part, afforded. In particular aspects, the test molecule is outside the training set of molecules.

In particular aspects, the molecular interaction is enzyme-substrate binding or interaction, protein-protein interaction or docking, protein-small molecule interactions, protein-nucleotide interactions, molecule-molecule interactions, surface-molecule interactions, protein activity inhibition or activation based on a molecular interaction or binding event, or modulation or inhibition of P450 drug metabolism.

Further aspects provide a method for predicting a numerical value for a molecule, comprising: constructing a series of decision trees based on a training set of molecules, each tree generated according the method of claim 1 and each tree associated with a specific molecular concentration; and tracking the designation of each molecule in the training set to provide a respective set of threshold concentrations, corresponding in each case to the concentration at which the respective molecule changes designation from one that does not demonstrate the molecular interaction to one that does, or vice versa, to provide for evaluation of the relative affinity (pKi) of a molecule to that of a specific interaction partner of interest. In particular embodiments, a numerical value (pKi) for a test molecule is determined by application of LWRP as described herein.

In particular aspects, the method is at least in part implemented on a computer. In certain embodiments, the methods comprise implementing at least one of evaluating, mapping and recursively partitioning on a computer. Certain embodiments comprise implementation of at least a part of the method over a wide-area network and/or local area network.

Additional aspects provide a recursive partitioning method for evaluating a test molecule for regioselective reactivity, comprising: establishing a set of molecular descriptors relevant for evaluating reactive sites or atomic positions within a molecule, the number of descriptors in the set equal to m; establishing a training set of molecules, each molecule having a known reactivity response upon exposure to a defined environment; evaluating, for each descriptor, each reactive site in the training set to provide at least one respective set of numerical descriptor-reactive site values for each descriptor; mapping each reactive site in the training set to respective column vectors by either: normalizing the respective descriptor values of each reactive site by scaling and translation, or by assigning, within each respective set of descriptor-reactive site values and based on the relative magnitude of the descriptor-reactive site values, a descriptor-reactive site rank value for each reactive site to provide a respective ranked set of reactive sites for each descriptor and centering the rank values (e.g., at zero), wherein each reactive site is mapped into m-dimensional space as the respective column vector to provide an m-dimensional space comprising a training set of column vectors; recursively partitioning the training set of column vectors (i.e., the reactive sites of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test molecule for reactivity response upon exposure to a defined environment; and providing the evaluation to a user of the method. In certain aspects, the method further comprises: selecting a test molecule; determining a test ranking vector (ranking column vector) for the test molecule by assigning, with respect to each descriptor, a test rank value to the test molecule, wherein the assigned test rank value: is that of a training set molecule having a matching descriptor-molecule value; is a test rank value that is a mean rank value where the test descriptor-molecule value lies between those of two training set molecules; is a rank that is one rank higher than the maximum rank of the training set; or is one rank lower than the minimum rank of the training set, to provide for a test ranking vector mapped within the m-dimensional array; and evaluating the test molecule (test ranking vector) by application of the decision tree having interior nodes corresponding to LWRP-selected hyperplanes, wherein evaluating a test molecule for reactivity response upon exposure to a defined environment is, at least in part, afforded.

Yet additional embodiments provide a recursive partitioning method for evaluating a stock, comprising: establishing a set of financial descriptors relevant for evaluating stock in a company, the number of descriptors in the set equal to m; establishing a training set of stocks, each stock having a known value response; evaluating, for each descriptor, each stock in the training set to provide a respective set of numerical descriptor-stock values for each descriptor; mapping each stock in the training set to respective column vectors by either: normalizing the respective descriptor values of each reactive site by scaling and translation; or by assigning, within each respective set of descriptor-stock values and based on the relative magnitude of the descriptor-stock values, a descriptor-stock site rank value for each stock to provide a respective ranked set of stocks for each descriptor and centering the rank values (e.g., at zero), wherein each stock is mapped into m-dimensional space as the respective column vector to provide an m-dimensional space comprising a training set of column vectors; recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test stock for value response; and providing the evaluation to a user of the method. In certain aspects, the method further comprises: selecting a test stock; determining a test ranking vector (ranking column vector) for the test stock by assigning, with respect to each descriptor, a test rank value to the test stock, wherein the assigned test rank value: is that of a training set stock having a matching descriptor-stock value; is a test rank value that is a mean rank value where the test descriptor-stock value lies between those of two training set stocks; is a rank that is one rank higher than the maximum rank of the training set; or is one rank lower than the minimum rank of the training set, to provide for a test ranking vector mapped within the m-dimensional array; and evaluating the test stock (test ranking vector) by application of the decision tree having interior nodes corresponding to LWRP-selected hyperplanes, wherein evaluating a test stock for value response, at least in part, afforded.

Further embodiments provide a recursive partitioning method for evaluating insurance risk for a particular property/property owner/client, comprising: establishing a set of risk descriptors relevant for evaluating a client, the number of descriptors in the set equal to m; establishing a training set of risks, each risk having a known loss probability; evaluating, for each descriptor, each risk in the training set to provide a respective set of numerical descriptor-risk values for each descriptor; mapping each risk in the training set to respective column vectors by either: normalizing the respective descriptor values of each risk by scaling and translation; or by assigning, within each respective set of descriptor risk values and based on the relative magnitude of the descriptor-risk values, a descriptor-risk rank value for each risk to provide a respective ranked set of risks for each descriptor and centering the rank values (e.g., at zero), wherein each risk is mapped into m-dimensional space as the respective column vector to provide an m-dimensional space comprising a training set of column vectors; recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test property/property owner/client; and providing the evaluation to a user of the method. In certain aspects, the method further comprises: selecting a test insurance risk; determining a test ranking vector (ranking column vector) for the test insurance risk by assigning, with respect to each descriptor, a test rank value to the test insurance risk, wherein the assigned test rank value: is that of a training set insurance risk having a matching descriptor-insurance risk value; is a test rank value that is a mean rank value where the test descriptor-insurance risk value lies between those of two training set insurance risk; is a rank that is one rank higher than the maximum rank of the training set; or is one rank lower than the minimum rank of the training set, to provide for a test ranking vector mapped within the m-dimensional array; and evaluating the test insurance risk (test ranking vector) by application of the decision tree having interior nodes corresponding to LWRP-selected hyperplanes, wherein evaluating a test insurance risk is, at least in part, afforded.

Yet further embodiments provide a recursive partitioning method for medical treatment decisions for a particular patient, comprising: establishing a set of patient descriptors relevant for evaluating a treatment decision, the number of descriptors in the set equal to m; establishing a training set of patients, each having a known treatment outcome; evaluating, for each descriptor, each patient in the training set to provide a respective set of numerical descriptor-patient values for each descriptor; mapping each patient in the training set to respective column vectors by either: normalizing the respective descriptor values of each patient by scaling and translation; or by assigning, within each respective set of descriptor-patient values and based on the relative magnitude of the descriptor-patient values, a descriptor-patient rank value for each patient to provide a respective ranked set of patients for each descriptor and centering the rank values (e.g., at zero), wherein each patient is mapped into m-dimensional space as the respective column vector to provide an m-dimensional space comprising a training set of column vectors; recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a treatment decision; and providing the evaluation to a user of the method. In certain aspects, the method further comprises: selecting a test patient; determining a test ranking vector (ranking column vector) for the test patient by assigning, with respect to each descriptor, a test rank value to the test patient, wherein the assigned test rank value: is that of a training set patient having a matching descriptor-patient value; is a test rank value that is a mean rank value where the test descriptor patient value lies between those of two training set patients; is a rank that is one rank higher than the maximum rank of the training set; or is one rank lower than the minimum rank of the training set, to provide for a test ranking vector mapped within the m-dimensional array; and evaluating the test patient (test ranking vector) by application of the decision tree having interior nodes corresponding to LWRP-selected hyperplanes, wherein evaluating a test patient is, at least in part, afforded.

Additional embodiments provide a computer apparatus for evaluating a question relating to a test object, comprising: a computer comprising a processor and a storage device connected to the processor; an object descriptor set database stored on the storage device, wherein the object descriptor set database comprises a plurality object descriptors; a training set database stored on the storage device, wherein the training set database comprises plurality of training objects; a data set of descriptor-object values derived from evaluation of the object descriptor set and the training dataset; a program stored on the storage device for controlling the processor, wherein the program is operative with the processor to (i) map each object in the training set to respective column vectors by either: normalizing the respective descriptor values of each object by scaling and translation, or by assigning, within each respective set of descriptor-object values and based on the relative magnitude of the descriptor-object values, a descriptor-object rank value for each object to provide a respective ranked set of objects for each descriptor and centering the rank values (e.g., at zero), wherein each object is mapped into m-dimensional space as the respective column vector to provide an m-dimensional space comprising a training set of column vectors; and (j) recursively partitioning the training set of column vectors (i.e., the objects of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test object for an object interaction; and providing the evaluation to a user. In certain aspects, the test object is selected from the group consisting of molecular interaction, regioselectivity to site reactivity, or stock valuation, insurance risk, and medical diagnosis or treatment. In certain aspects, the method further comprises a user database stored on the storage device, wherein the program is operative with the processor to store user information in the user database, and update user information when new user information is received. In certain aspects, the program is further operative with the processor to track user information.

Further embodiments provide a software program, stored on a reproducible medium, computer or database, comprising code suitable for application of one or more decision trees having interior nodes corresponding to LWRP-selected hyperplanes for executing the methods of any one of claims 1, 7, 12, 16, 20 and 24.

Yet further embodiments provide a software program, stored on a reproducible medium, computer or database, comprising code suitable for application of one or more decision trees having interior nodes corresponding to LWRP-selected hyperplanes as described herein.

### BRIEF DESCRIPTION OF THE DRAWINGS

FIG. 1 shows, according to particular inventive aspects, a decision tree (2C9) produced by random vector selection.

FIG. 2 shows, according to preferred inventive aspects, a decision tree (2C9) produced by an inventive algorithm, referred to herein as “Line-Walking Recursive Partitioning” (“LWRP”).

### DETAILED DESCRIPTION

Particular aspects provide a novel method which uses a small or reduced number of descriptors relative to prior art methods. In certain embodiments, descriptors (e.g., nine descriptors) of the shape, polarizability, and charge of a molecule are used. Preferably, the descriptors are selected based on understanding of what is important in binding to drug metabolizing molecules, and on their ability to describe the differences in all training sets. The small number of descriptors facilitates interpretation, and allows for an enhanced ability to extrapolate beyond the training set to predict properties of new chemical entities.

Additional aspects incorporate elements from support vector machines (“SVM”), and recursive partitioning. More specifically, the training set is considered as a collection of points in a ‘high-dimensional space,’ each point with a label corresponding to some chemical property. Each dimension of the space corresponds to a chemical descriptor. In this geometric setting, dissection of the space into regions is decided, each region containing points having a common label. In keeping with SVM, the number of dimensions is high enough to ensure that the dissection can be accomplished with a single decision, with few training errors (e.g., points with labels differing from the predominant label in the region). Also, the decision is in the form of a hyperplane that incorporates information from all of the descriptors simultaneously. Inventive embodiments incorporate this latter feature into recursive partitioning; the space is dissected by a hyperplane into two regions, then each region is dissected into two regions, and so on until each of the resulting regions contains points having a common label.

Additional aspects provide a novel method which uses a novel ‘line-walking algorithm’ to efficiently locate suitable hyperplanes for recursive partitioning. In preferred aspects, such line-walking embodiments additionally comprise use of a small or reduced number of descriptors relative to prior art methods. More specifically, a novel tactic/method referred to by applicants as “line-walking” is also employed and described in detail below in order to efficiently locate a hyperplane that minimizes the number of training errors at each step. Specifically, particular Examples provided herein disclose and describe a novel method, called line-walking recursive partitioning (LWRP), for partitioning diverse structures based on chemical properties, wherein relatively few descriptors of the shape, polarizability, and charge of the molecule are used. For the following exemplary implementations, a training set of over 600 compounds, and a validation set of 100 compounds for the cytochrome P450 enzymes 2C9, 2D6 and 3A4 has been utilized. The LWRP algorithm itself incorporates elements from support vector machines (SVM) and recursive partitioning, while circumventing the need for linear or quadratic programming methods required in SVM. LWRP is compared with a many-descriptor SVM model, using the same dataset as described in the literature¹. The line-walking method, using nine descriptors, predicted the validation set with about 84-90% accuracy, a success rate comparable to the SVM method. Furthermore, line-walking was able to find errors in the assignment of inhibitor values within the validation set for the 2C9 inhibitors. When these errors are corrected, the model predicts with an even higher level of accuracy. While this method is applied to P450 enzymes in the working Examples herein, the method is of general use in partitioning molecules based on their structural attributes and potential chemical and/or biochemical interactions. The specific training sets and descriptors utilized can be judiciously chosen for evaluation of a particular interaction of interest.

### PREFERRED EXEMPLARY EMBODIMENTS

In certain aspects, a set of descriptors are chosen, and values associated with each descriptor are assigned to every molecule within a “training set.” A training set, as used in this example, is a group of molecules with known responses to a given interaction of interest (e.g. enzyme inhibition). The values assigned to each descriptor-molecule combination are then ranked with respect to the relative magnitude of the descriptor value for each compound within the training set (the lowest magnitude value being assigned the rank of 1, the next lowest is ranked 2 etc.). The rankings associated with each descriptor-molecule combination are then shifted such that they are centered about 0 (New Rank=Rank−[(n+1)/2], wherein n=number of molecules in training set).

For each descriptor, the net result is a series of points (representing molecules) centered about an origin, 0. For each molecule, the net result is a series of ranks (representing descriptor-molecule relative magnitudes). The molecules may then be considered as points within ‘m-dimensional space,’ wherein the coordinates within this space are provided by the respective descriptor-molecule rankings (m=the number of descriptors). Within this m-dimensional space the molecules within the training set can be partitioned by imposing a splitting hyperplane analytically determined to most completely segregate the molecules into those that demonstrate a desired characteristic (e.g., enzyme inhibition) and those that do not demonstrate said characteristic. This splitting process will occur repeatedly until the molecules are segregated into ‘pure’ groups (a.k.a leaves) (pure: meaning all the molecules within the group either posses, or do not posses) the characteristic of interest.

Once the training set has been partitioned into leaves, molecules outside of the training set can be evaluated to determine if said molecules posses the characteristic of interest. For this process, a molecule is assigned the rank of a training set compound with a matching descriptor-molecule magnitude. If the magnitude of the descriptor-molecule value falls between two descriptor-molecule values in the training set the molecule being evaluated is assigned a rank that is the mean of the two training set molecules. In cases where the magnitude of the descriptor-molecule value is greater than the maximum value found in the training set the molecule is assigned a rank that is one unit greater than the maximum rank (rₘₐₓ+1). In cases where the magnitude of the descriptor-molecule value is less than the minimum value found in the training set the molecule is assigned a rank that is one unit less than the minimum rank (rₘᵢₙ−1). Once the ranking is completed the set of coordinates deriving from the descriptors are used to position the molecule in m-dimensional space. By subsequently applying the splitting hyperplanes derived from the training set, the molecule can be evaluated to posses or not posses the characteristic of interest depending upon which leaf of the decision tree to which the molecule is assigned.

Applicants' conception encompasses the use of these methods for evaluating any molecular interaction, including, but not limited to, enzyme-substrate binding, protein-protein docking, protein-small molecule interactions, protein-nucleotide interactions, molecule-molecule interactions, surface-molecule interactions and protein activity inhibition or activation based on molecular binding events. The particular molecular interaction of interest will determine the nature and scope of the training set. The training set comprises a set of molecules (or proteins, nucleotides, surfaces etc.) that have been screened for a given interaction of interest. Preferably, some members of the training set will demonstrate the interaction and some will not demonstrate the interaction. In particular embodiments, at least one member of the training set will demonstrate the interaction and at least one will not demonstrate the interaction.

Since molecular binding events are inherently concentration dependent, a standard benchmark concentration number may be applied in the evaluation of the compounds within the training set. The specific concentration number will vary depending on the specific event of interest and the context under which the event occurs. For example, in the evaluation of molecules of interest for drug design, a concentration of 10 μM may be used, as this is generally accepted to be a physiologically relevant concentration for a drug within a subject. Moreover, multiple concentrations may be considered in the evaluation of the training set. Through considering multiple concentrations, one can develop a series of decision trees each associated with a specific concentration. As the different trees are constructed a given molecule may change designation from one which does not demonstrate the property of interest (g=−1) to one which does (g=1) (alternatively 1→−1). By tracking the designation of each compound in the set a ‘threshold concentration’ can be defined for each member. This process allows for the evaluation of a relative affinity (e.g. pKi) of a molecule to that of a specific interaction partner of interest. This process can be extended to molecules outside of the training set utilizing the methodology described above.

Preferred implementations utilize relatively few ‘descriptors’ (e.g., about 8, about 9, about 10, about 11, about 12, preferably ˜10), thereby allowing for a more general evaluation of the training set. This more general evaluation facilitates 1) a more robust model, allowing for substantial prediction outside of the training set and 2) a more intuitive molecular segregation, facilitating visualization and interpretation of the molecular properties of relevance. The specific descriptors utilized may vary depending on the specific implementation of the method. Generally, molecular descriptors associated with the polarizability, pKa, size, shape, volume, surface area, atomic composition, hydrophobicity and polarity of both the molecule as a whole and the component atoms and bonds within a molecule are considered to be important in the evaluation of molecular interactions. Many forms of molecular descriptors have been developed for similar applications and are readily available to one skilled in the art.

Preferred embodiments provide a method that first evaluates each molecule within a training set within the context of each molecular descriptor. The result of this process is a numerical quantity associated with each molecule-descriptor combination is generated. For each descriptor, the molecules are then assigned a rank, based upon the relative magnitude of the descriptor-molecule combination. The descriptor-molecule combination with the lowest magnitude is assigned the rank of 1, the next lowest descriptor-molecule combination is assigned a rank of 2 and so on until each molecule within the training set is assigned a rank for each descriptor. When two or more molecules posses the same magnitude value for a given descriptor the rank for all molecules is assigned as the average of the ranks. (e.g. if molecules provisionally ranked 2, 3 and 4 have the same magnitude, then all are assigned the rank 3). Once the ranking process is completed the ranks are then normalized to be centered about 0 (by applying the normalizing function described above). Once the ranking and normalization process are completed each molecule can be considered as a point in m-dimensional space.

Once the molecules in the training set have been reduced to points within a geometric space, analytical tools can be utilized to best sort the points into those which have a property of interest and those which do not have the property of interest. In the construction of a decision tree, a series of splitting events subdivides the points until the points have been sorted into ‘pure’ groups (groups wherein all the molecules either posses or do not posses the property of interest). With respect to the splitting events, many potential methods exist to generate the splitting hyperplane, however the preferred method; ‘line walking’ as referred to and described herein is a novel process through which splitting hyperplanes are generated.

Utilizing the duality principle in projective geometry, each point within the m-dimensional space is converted to a hyperplane in a codimentional space. In an ambient projective space of dimension m, the points (dimension 0) correspond with hyperplanes (codimension 1) and a line joining two points within the m-dimensional space correspond with the intersection of two hyperplanes within codimention 1. For each molecule, a hyperplane is generated in the codimension utilizing the coordinates describing the molecule's position in the m-dimensional space. The result is a set of hyperplanes in the codimentional space. For any given hyperplane there exists point(s) of intersection with other hyperplane(s) within the codimensional space. This point of intersection correlates [with a] line in the m-dimensional space which connects the two points. Once a line has been identified in the m-dimensional space, the Matthews correlation coefficient, λ (described below), is utilized to evaluate how effectively this line partitions the points (e.g. molecules) into pure groups. The term ‘line walking’ derives from the process wherein the hyperplanes in the codimentional space are ‘walked’ along and at each point where an intersection occurs λ is evaluated. The intersection possessing the highest value of λ is determined to represent the splitting hyperplane in the m-dimensional space. Once the new groups have been generated, the process is repeated until the groupings are ‘pure.

### EXAMPLE 1

### Development and Description of Novel Line Walking Method

Overview. Particular examples provided herein disclose and describe a novel method, called line-walking recursive partitioning (LWRP), for partitioning diverse structures based on chemical properties, wherein relatively few descriptors of the shape, polarizability, and charge of the molecule are used. For the following exemplary implementations, a training set of over 600 compounds, and a validation set of 100 compounds for the cytochrome P450 enzymes 2C9, 2D6 and 3A4 has been utilized. The LWRP algorithm itself incorporates elements from support vector machines (SVM) and recursive partitioning, while circumventing the need for linear or quadratic programming methods required in SVM. LWRP is compared with a many-descriptor SVM model, using the same dataset as described in the literature¹. The line-walking method, using nine descriptors, predicted the validation set with about 84-90% accuracy, a success rate comparable to the SVM method. Furthermore, line-walking was able to find errors in the assignment of inhibitor values within the validation set for the 2C9 inhibitors. When these errors are corrected, the model predicts with an even higher level of accuracy. While this method is applied to P450 enzymes in the working Examples herein, the method is of general use in partitioning molecules based on their structural attributes and potential chemical and/or biochemical interactions. The specific training sets and descriptors utilized can be judiciously chosen for evaluation of a particular interaction of interest.

In this example the chemical property being predicted is inhibition (g), where g=1 denotes an inhibitor and g=−1 denotes a non-inhibitor.

Evaluation

The Matthews correlation coefficient λ, given by

$$λ = \frac{{t}_{+} {t}_{-} - {f}_{+} {f}_{-}}{\sqrt{( {t}_{+} + {f}_{+} ) ( {t}_{+} + {f}_{-} ) ( {t}_{-} + {f}_{+} ) ( {t}_{-} + {f}_{-} )}} ,$$

was used to evaluate a predictor's accuracy¹². If the denominator is zero, then either all of the g values are the same or all of the predictions are identical. Neither case is interesting, so this case can be disregarded. In any other case, |λ|≦1. It is can be shown that if predictions are made completely by chance, then λ=0. The case λ=1 corresponds to a perfect predictor while λ=−1 corresponds to a perfect “anti-predictor”.

In this exemplary implementation, the true positives, t₊, were those g=1 compounds correctly predicted, true negatives, t were those g=−1 compounds correctly predicted, false positives, ƒ₊, were g=−1 compounds incorrectly predicted, and false negatives, ƒ₋, were g=1 compounds incorrectly predicted.

Theoretical Method Development—

Suppose C={c₁, c₂, . . . , cₙ} is a set of n compounds in a training set and D={d₁, . . . , dₘ} is a set of m descriptors, thought of as real-valued functions. Define aᵢⱼ=dⱼ(cᵢ), i.e., the value of the j^{th} descriptor applied to the i^{th} compound. Furthermore, suppose there is some property we wish to predict, e.g., inhibition of cytochrome P450 2C9. For each compound cᵢ, we define gi 1 if it has the property and gi=−1 otherwise.

Map Ranking Scheme

In similar [prior art] studies, the descriptor values of the training set are often normalized to the interval [−1,1] by scaling and translation, i.e., compound cᵢ is mapped to the column vector rᵢ=[rᵢ₁, rᵢ₂, . . . rᵢₘ]^{t}, where rᵢⱼ=2(aᵢⱼ−aₘₑₐₙⱼ)/(aₘₐₓⱼ−aₘᵢₙⱼ). Here, aₘₑₐₙⱼ represents the mean of aₘₐₓⱼ and a_{min,j} rather than the mean of all of the aᵢⱼ values. Since the distributions of the descriptors are likely to vary considerably, it can be asked whether this will distort the effects of linear algebraic computations to follow. Also, it is unlikely that the collection of compounds will be well-centered at the origin.

The following “ranking” scheme was proposed and developed to compensate for these prior art shortcomings. For each descriptor dⱼ, the compounds are sorted in ascending order of their aᵢⱼ values. Rank 1 is assigned to the lowest, rank 2 to the next lowest, etc. until rank n is assigned to the compound with the highest aᵢⱼ value. If a group of compounds have the same aᵢⱼ value, each compound in the group is assigned the mean of the ranks of the group. For instance, if the four lowest compounds all have the same aᵢⱼ value, then each is assigned a rank of 2.5 (the mean of 1, 2, 3, and 4). Finally, the value rᵢⱼ is defined as the rank minus (n+1)/2; this centers the list of rᵢⱼ values at zero. Each compound cᵢ is then mapped into m-dimensional space as the column vector rᵢ=[rᵢ₁, rᵢ₂, . . . rᵢₘ]^{t}. The origin of this space would represent a compound each of whose aᵢⱼ values is the median for the respective descriptor.

Predictions based both on traditional normalization and the instant ranking scheme are compared in the results section presented elsewhere herein.

Splitting Planes and Decision Trees

The prediction strategy rests on the ability to separate the entire training set of vectors R {r₁, r₂, . . . , rₙ} into pieces, depending on their corresponding gi values. A splitting hyperplane is determined by its normal vector n; the set R is split into two subsets R⁺={rᵢ: n·rᵢ>1} and R⁻={rᵢ: n·rᵢ<1}. If necessary, the components of n can be perturbed slightly so that R is in fact partitioned into R⁺ and R⁻, i.e., for no i, is n·rᵢ=1. The aim is to choose n so that the sets of g values of the subsets are more “pure” than the set of g values of the original set. More formally, some objective function ƒ (“purity” function) is to be maximized over choices of n, where ƒ (n) is determined by the g values of compounds in R⁺ and in R⁻. Suitable choices for ƒ are discussed in the next section.

The same process is repeated on each set R⁺ and R⁻ if need be; a set whose g-values are either all 1's or all −1's need not be split further. The result is a “decision tree” whose internal vertices are labeled with the n vector and whose leaves are labeled “−1” and “1” depending on the common g value of the compounds in the corresponding set. To make a prediction of the g value of a test compound, one determines the ranking vector r for the compound in question. To determine each component of r, the following rules are used: If the descriptor value matches the value for a compound in the training set, then the r-value of the test compound is set to that of the training compound. If the descriptor value is between those of two training compounds, then the mean of the r-values of the training compounds is used. Finally, r-values of rₘₐₓ+1 or rₘᵢₙ−1 are used for test compounds whose descriptor values lie above or below the entire set of test compounds' descriptor values.

To make the actual prediction, beginning with the root node, the scalar product n·r is computed. If the result is less than 1, the left branch is followed. Otherwise, the right branch is followed. This process continues until a leaf is encountered. The label of the leaf is the predicted g value.

Measures of Purity and Success

There are many proposed measures of the “purity” function ƒ. A naive choice of ƒ(n) would be

$$f ( n ) = \vert {\sum }_{{c}_{i} ∈ {R}^{+}}^{} {g}_{i} - {\sum }_{{c}_{i} ∈ {R}^{-}}^{} {g}_{i } \vert .$$

This function measures the extent to which a splitting plane separates the positive g values from the negative g values. Among the drawbacks to this function is that there are situations where the maximum is achieved by not splitting R at all. For instance, this occurs if a single compound with g=−1 is surrounded by compounds with g=1.

For present purposes, applicants use the Matthews coefficient as a measure of purity

$$λ = \frac{{t}_{+} {t}_{-} - {f}_{+} {f}_{-}}{\sqrt{( {t}_{+} + {f}_{+} ) ( {t}_{+} + {f}_{-} ) ( {t}_{-} + {f}_{+} ) ( {t}_{-} + {f}_{-} )}}$$

where t₊, t₋, ƒ₊, and ƒ₋ are defined by

t₊=the number of g=1 compounds in R⁺,

t₋=the number of g=−1 compounds in R⁻,

ƒ₊=the number of g=−1 compounds in R⁺, and

ƒ₋ =the number of g=1 compounds in R⁻.

The effort becomes to find a plane that maximizes |λ| since |λ|=1 precisely when the plane perfectly splits the set.

An Exemplary Inventive “Line-Walking” (LWRP) Tree-Building Algorithm

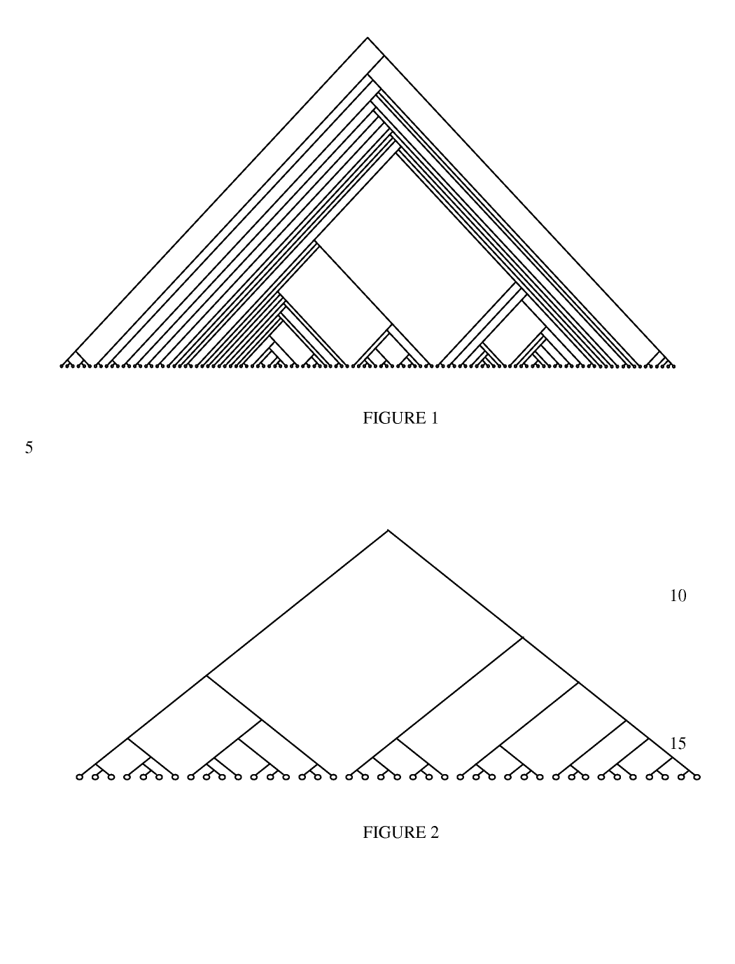

Constructing decision trees based on small (m≈10) descriptor sets involves working in vector spaces of the same number of dimensions as there are descriptors. A initial strategy was to select a large number of unit vectors u (chosen randomly from a uniform distribution over the unit m-sphere.) Then for each u, the value of s that maximized ƒ(su) could be determined in linear time. The best of these su vectors was then set as n. To produce a “reasonable” tree by this method required generating a large number (≈10,000) of unit vectors even when m is small. Therefore, trees took a considerable length of time to generate. As shown in FIG. 1, even with a large number of vectors, the decision trees that resulted from this strategy tended to be unbalanced and have higher numbers of levels and leaves than desired—the number of potential decisions to make a prediction seemed excessive and many of the leaves corresponded to single compounds, and so a new algorithm, called “Line-Walking Recursive Partitioning”, or LWRP to overcome these drawbacks was developed.

Recalling that there are m descriptors being used, the first step in choosing a splitting plane for a set R is to choose vectors {r₁, r₂, . . . , rₘ} from R, at random.

Given an m-element subset R′={r₁, r₂, . . . , rₘ} of R, a single iteration of the LWRP algorithm consists of the following steps:

(1) Compute the vector p such that p·rᵢ=1 for all rᵢ in R′.

(2) Choose a value rₖ at random from R′.

(3) Compute the vector q such that q·rₖ=2 and q·rᵢ=1 for all i≠k.

(4) Defining L(t)=tq+(1−t) p, determine for each rₛ in R the value tₛ such that L(tₛ)·rₛ=1. L is the “line” mentioned in the name “line-walking algorithm.”

(5) Maximize ƒ(L(tₛ)) over s. If several values of s maximize ƒ(L(tₛ)), choose one at random.

(6) Replace rₖ with rₛ in R′. The new vector p is equal to L(tₛ), so the next iteration begins at step 2.

There are several possibilities for conditions to halt the algorithm. The halting criterion initially used was if the maximized value of ƒ remains unchanged for a pre-determined number of consecutive iterations. Subsequently, it was decided to permute the vectors in R′, and adopt each in succession as rₖ in step 2 if the maximum value of ƒ remained unchanged. The algorithm halts if all of the vectors in R′ are exhausted in this manner. This condition results in locating a local maximum for ƒ in the sense that no compound in R′ can be substituted resulting in raising the value of ƒ(L(tₛ)).

Steps 1 and 3 are the most computationally intensive in the LWRP algorithm as each involves row reducing an m×(m+1) augmented matrix; standard techniques accomplish this in O(m³) time. Nonetheless, for m≈10, this algorithm generates trees about as quickly as using 10,000 random vectors to generate hyperplanes. Also, the LWRP trees have far fewer leaves and levels than trees produced by random vectors.

For example, the trees in FIGS. 1 and 2 were produced from the compounds in the 2C9 training set using the same nine descriptors in TABLE 1 (see below under working EXAMPLE 2). Each interior node in the tree in FIG. 1 represents a hyperplane selected from random vectors while each interior node in the tree in FIG. 2 represents a hyperplane selected using LWRP. MOE generated each tree in about 30 seconds. The random-vector tree has 40 levels and 115 leaves, while the LWRP tree has eight levels and 39 leaves.

Evaluating pKi

Further embodiments are used to predict a numerical value for a compound; for example, to predict pKi values. Given a training set T of n compounds, together with their pKi values, and an algorithm A(t,c) that trains on T and predicts whether compound c has a pKi value above or below the threshold t. Algorithm A can then be applied along a range of thresholds to construct an algorithm B(c) that predicts a numerical value for the pKi of compound c.

In such further embodiments, the line-walking recursive partitioning (LWRP) algorithm described above is used as the algorithm A which returns −1 if the pKi of compound c is below t, and +1 if it is above c. The specific steps of this continuous algorithm are:
1. Choose a low starting threshold value t_{low}, a high ending threshold value t_{high}, and an interval value δ.
2. Set t₀=t_{low} and set i=0.
3. If tᵢ>t_{high} then proceed to step 7.
4. Compute mᵢ=A(tᵢ,c).
5. Let tᵢ₊₁=tᵢ+δ and increment i.
6. Return to step 3.
7. The left-hand endpoint 1 of the interval of prediction is the highest tᵢ such that mⱼ=+1 for all j≦i. If m₀=−1 then l=t_{low}−δ.
8. The right-hand endpoint r of the interval of prediction is the lowest tᵢ such that mⱼ−1 for all j≦i. If mₘₐₓ=+1 then r=t_{high}+δ.
   This algorithm returns an interval (l,r) with the interpretation that the pKi is between l and r.

### EXAMPLE 2

### The Inventive Method of Line Walking was Illustrated with Specific Descriptors and Training Set for Enzyme-Substrate Binding

Database Selection

Yap and Chen's database of compounds was selected as a ready-made collection of compounds already classified as inhibitors or noninhibitors¹. This database is a collection of CYP 2C9, 3A4 and 2D6 substrates and a collection of non-P450 substrates. The same training set and external validation set as Yap and Chen was used in this working Example.

Descriptor Selection

Descriptors were selected from ˜150 descriptors implemented in MOE; only the 2D descriptors were considered. Using Chemical Computing Group's Molecular Operating Environment (MOE) software, MOE's QSAR modeler, a least-squares fit to the g values of the training set was constructed. The descriptors that contributed the most to this fit and provided a rational explanation of size, polarizability, and charge were analyzed. A subset of similar descriptors was chosen based on the generality of the descriptor, and applicants' ability to understand the chemical feature underlying the descriptor. The goal was to describe the overall shape, flat versus round, and the overall surface charge of the molecule given only a two-dimensional representation of the compounds of interest.

TABLE 1 lists the nine descriptors, and a short synopsis (as described in MOE helpfiles) of each chosen for model development. The same descriptor set is used for each dataset, since they are thought to be fundamental descriptors for binding to cytochrome P450 enzymes and also to provide comparisons of performance among the enzymes. All computing and programming for the implementation described herein was done using the 2004.03 release of Chemical Computing Group's Molecular Operating Environment (MOE) software. Descriptors were calculated using QuaSAR-descriptor using default MOE charges.

Consensus Predictions

A single tree is rarely a good predictor of chemical properties, such as inhibition. Several authors have demonstrated the utility of consensus models whereupon a large number of different predictors are generated and then an overall prediction is based upon a simple majority of responses. The strategy is simple enough: An odd number of trees is generated and each is used to predict a chemical property. Whichever chemical property is predicted by the majority of the trees is returned as the consensus prediction.

TABLE 1
Descriptors used in Developing the Partitioning Models.

| Descriptor | Synopsis |
|---|---|
| vsa_hyd | Approximation to the sum of VDW surface areas of |
| | hydrophobic atoms. |
| vdw_vol | van der Waals volume calculated using a connection |
| | table approximation. |
| apol | Sum of the atomic polarizabilities (including |
| | implicit hydrogens) with polarizabilities taken |
| | from [CRC 1994]. |
| vdw_area | Area of van der Waals surface calculated using a |
| | connection table approximation. |
| weinerPol | Wiener polarity number: half the sum of all the |
| | distance matrix entries with a value of 3 as |
| | defined in [Balaban 1979]. |
| PEOE_VSA_NEG | Total negative van der Waals surface area. This is |
| | the sum of the vᵢ such that qᵢ is negative¹. The vᵢ |
| | are calculated using a connection table |
| | approximation². |
| zagreb | Zagreb index: the sum of dᵢ² over all heavy atoms i.³ |
| SlogP | Log of the octanol/water partition coefficient |
| | (including implicit hydrogens). |
| Bpol | Sum of the absolute value of the difference between |
| | atomic polarizabilities of all bonded atoms in the |
| | molecule (including implicit hydrogens) with |
| | polarizabilities taken from [CRC 1994]. |

¹The variable qᵢ denotes the partial charge on atom i.
²vᵢ denotes the accessible van der Waals surface area of atom i calculated from a connection table.
³dᵢ is defined as the number of heavy atoms to which atom i is bonded.

### EXAMPLE 3

### The Results for Implementation of the Method as Described herein above were Evaluated

Comparison with Yap and Chen—

The manuscript of Yap and Chen provide the data they used in the generation of their 10 model. The inventive line walking recursive partitioning with SVM was therefore validated and compared using the Yap and Chen database of 702 compounds. Specifically Yap and Chen trained on a 602 molecules, with an external validation set of 100 molecules to predict if a compound would be a substrate for CYP3A4, 2C9 or 2D6. This SVM method used between 200 and 300 descriptors to build the model. Descriptor sets were different for each training set. For 3A4, true binders to the enzyme where predicted 77% of the time, true noninhibitors 98% of the time, and the overall prediction had a Matthews coefficient of 0.83. For 2C9, true binders to the enzyme where predicted 82% of the time, true noninhibitors 99% of the time, and the overall prediction had a Matthews coefficient of 0.85. For 2D6, true binders to the enzyme where predicted 79% of the time, true noninhibitors 99% of the time, and the overall prediction had a Matthews coefficient of 0.83.

By contrast, the LWRP method used nine descriptors predicted with about 85-90% accuracy (concordance) as shown in TABLE 2.

TABLE 2
Prediction of inhibitors and noninhibitors with LWRP method and 9 Descriptors.

| | 2C9 | | 2D6 | | 3A4 | |
|---|---|---|---|---|---|---|
| Scheme | Normed | Ranked | Normed | Ranked | Normed | Ranked |
| Concordance | 90.60 | 90.10 | 89.20 | 89.60 | 85.00 | 84.80 |
| Specificity | 96.95 | 97.32 | 96.00 | 97.00 | 94.93 | 95.47 |
| Sensitivity | 61.67 | 57.22 | 62.00 | 60.00 | 55.20 | 52.80 |
| Λ | 0.658526 | 0.633335 | 0.662455 | 0.660285 | 0.570278 | 0.561880 |

For each enzyme and scheme, ten forests each consisting of 101 trees were constructed. The data in TABLE 2 represent the means from these runs. In the table, “Scheme” denotes whether the descriptor values were normalized to the interval [−1,1] or ranked by the ranking scheme detailed above, “Concordance” denotes the percentage of compounds correctly predicted, “Specificity” denotes the percentage of g=−1 compounds correctly predicted, “Sensitivity” denotes the percentage of g=+1 compounds correctly predicted, and λ is the Matthews coefficient.

Overall the models do a good job of predicting inhibitors and non-inhibitors given the nature of the dataset, as described below. The models are very good at predicting noninhibitors with about a 94-97% success rate. The ‘ranking’ scheme tends to favor the predominant g=−1 compounds, and the traditional ‘normalizing’ scheme performs slightly better overall, using Matthews coefficients as a basis for overall comparison. The lowest success is with 3A4, which would be expected since it is very difficult to define what is an inhibitor as a results of the non-Michaelis-Menton nature of this enzyme^{13,14}. The 2C9 and 2D6 enzymes have distinct pharmacophores^{6,15 16}, so predicting non-inhibitors might be expected to be more straight-forward. The lower ability to predict binders to each enzyme stems in large part from the training set which is likely to have a number of false negatives, since it is assumed that a compounds that are not reported as inhibitors are not inhibitors (see below for more details). Since Ki or IC50 values have only been reported for some compounds that are substrates, and all substrates are competitive inhibitors, most certainly this assumption is not 100% valid. Given the nature of the problem it is therefore difficult to know what is not an inhibitor of any of these enzymes.

Of the two different descriptor scaling schemes, map ranking and normalization, no clear-cut winner could be determined. However, normalization could lead to potential problems when considering unique compounds that have descriptors values outside the range of the training set. For example, if a new compound is evaluated and found to have a normalized value of 2, relative to the training set values, this has the potential to dominate the prediction. However, the map ranking method would still give this compound a descriptor value very close to the highest value in the training set. According to particular aspects, when more diverse structures are encountered, the map ranking scheme provide a more robust model.

A primary difference between LWRP as disclosed and illustratively implemented herein, and other reported prior art methods such as simple recursive partitioning and SVM methods, is that the LWRP can perform at a similar level with significantly fewer descriptors. All other reports in the literature that distinguish between inhibitors of, for example, different P450 enzymes use a large number of descriptors (e.g., between 20-60 descriptors per 100 molecules in the training set) to develop a significant model. The novel LWRP approach disclosed herein provides a potentially less perfect solution for the training set, but only uses about 1 descriptor per 100 molecules in the training set. Significantly, using a large number of descriptors, while providing a better description of the training set, means that only molecules related to those in the training set can be accurately predicted. In fact, the training set, and external validation set of Yap and Chen were chosen such that they shared a common ‘chemical space,’ based on the descriptors that were used in the model such that “ . . . compounds of similar structural and chemical features were evenly assigned into separate datasets”¹. Arimoto et al.,¹⁷ came to the same conclusion when comparing models for 3A4 inhibition. They used molecular fingerprints to determine that their models only did well when predicting the affinity of compounds related to those in the training set.

Therefore, according to preferred aspects, the relatively low or minimum basis set LWRP embodiments implemented herein provide more extensible results, because a relatively small number of descriptors are used.

Choice of Descriptors/Independence of Specific Descriptors—

The descriptors in TABLE 1 were chosen from the available MOE descriptors to provide information about the size, shape, and charge distribution of each molecule. In general it is believed that the three major P450 enzymes involved in drug metabolism cover the chemical space of drug-like-molecules in that both 2D6 and 2C9 metabolize medium sized, rounder molecules, while very large molecules are metabolized by 3A4. Most drug molecules exceed 200 Daltons for their molecular weight, while molecules smaller than that, such as inhalation anesthetics, are metabolized by CYP2E1. CYPs 2D6 and 2C9 further discriminate based on charge, with 2C9 binding negative charges, and 2D6 binding positive charges. Our descriptors selection is meant to encompass these features. Unlike other prior art models, which optimize the descriptors based on the training set for each enzyme we used the same descriptors for each of the three enzymes. According to particular inventive aspects, use of the same descriptors facilitates filtering a large dataset into each ‘bin’ to classify a compound as a 3A4, 2C9, or 2D6 inhibitor.

Another advantage of the LWRP minimum basis set model is that it allows us to understand which features are important in determining binding for a given molecule. This has the obvious advantage of affording and facilitating rational redesign, for example by a medicinal chemist, of a molecule to either bind, or not bind to a given P450. Prior art models with many descriptors rely on an iterative approach, in which a structure is proposed and tested with the model, and the features that influence differential binding are not apparent. Using the present inventive embodiments, the major features important in placing a given molecule in a bin for inhibitor, or non-inhibitors can be determined. For example, the major determinants of a compound being a 2C9 substrate are “vsa_hyd,” and “PEOE_VSA_NEG.” which describe hydrophobic surface area and negative charge on the surface of the molecule, respectively. This fits with the expectations based on a hydrophobic binding site,¹⁸ and a site that interacts with a negative charge on the inhibitor¹⁵. In yet further inventive embodiments, trees are labeled, based on the major descriptors used in the decision, affording an understanding of why related molecules are either inhibitor or noninhibitors.

The nature of the Yap and Chen database needs to be considered when assessing the quality of the predictions. The dataset was constructed from literature data for inhibition. Any compound that exhibits inhibition, no matter how strong, is considered an inhibitor. Non-inhibitors are compounds taken from “ . . . well-studied agents that are known inhibitors/substrates/agonists of proteins other than that enzyme . . . ” and assumes that because an agent has been well-studied and not reported to be an inhibitor of a P450, it is not an inhibitor. These are reasonable assumptions but obviously some exceptions will exist. Thus, very high predictive capabilities for this dataset are not to be expected, and in fact the error in the training set of inhibitor and noninhibitors is likely to be over 20%. One example is isoconazole, an antifungal agent closely related to a number of imidazole based inhibitors (such as miconazole shown below in Scheme 1) of mammalian P450 enzymes which function by inhibiting fungal P450 enzymes. This compound has not been reported to be a 3A4, 2D6, or 2C9 inhibitor, but is always predicted by the present inventive models to be an inhibitor. In fact this molecule inhibits mammalian aromatase, a P450 19, but has not been tested for 3A4, 2D6 or 2C9 inhibition since it is administered topically. Thus, predicting this to be a non-inhibitor is almost certainly incorrect. If it is assumed to be an inhibitor, the present inventive success rate is increased by an additional 4 to 8%.

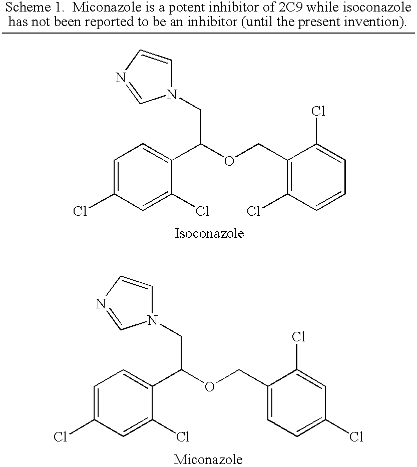

Another obvious problem with the 3A4 dataset is that Yap and Chen report 312 compounds in the set to be substrates, and only 216 to be inhibitors. Since by definition all substrates for a given P450 are competitive inhibitors this indicates that at least 16% of the noninhibitors are incorrectly labeled. This is most likely true for 2C9 and 2D6 as well. Thus, given the difficulties in defining what is or is not and inhibitor, the present inventive success rates are very good, and even better than presently reported.

According to further aspects, the inventive methods are used to predict potential tight binding compounds for each enzyme. For example, applicants speculate that only compounds that have Ki values lower than 10 μM are likely to be important physiological inhibitors²⁰. Therefore, according to further aspects, datasets are constructed, which define inhibitors by this more restrictive methodology, and models are developed using these new training sets.

One indication of a robust model is when it tells you about incorrect data in the dataset. To identify difficulties in the test set, 2C9 inhibitor/noninhibitors that are predicted incorrectly by at least 5 out 7 of the forests were sought. The compounds that gave false positive at least 5 out of 7 times were clonazepam and isoconazole. As described above isoconazole is a terminal imidazole compound structurally related to miconazole a potent 2C9 inhibitor (Scheme 1)²¹ and is most likely an inhibitor of 2C9. It has not been tested as such, because this compound is used topically. The compounds that gave false negatives 5 out of 7 times were lopinavir, lornoxicam, pioglitazone, sulconazole, sulfadiazine, sulfatroxazole. Of these lopinavir has been reported to “ . . . produce negligible inhibition of 2C9²², pioglitazone is a weak inhibitor of the *2 allylic variant not the native enzyme²³, sulconazole was found to have an incorrect structure which when fixed put it in the correct inhibitor category, sulfadazine is only a weak inhibitor²⁴, and no reference to sulfatrazole was found on Medline or the Web of Science, that supported it being an inhibitor of 2C9. Given these observations, two things become apparent: 1) that it is difficult to construct an accurate large dataset from the literature; and 2) that the LWRP model was able to find errors in the dataset.

The predictions were rerun making the corrections, and the results are shown in TABLE 3. The inventive predictive capacity was significantly increased by all measures. Given this “more correct” testing set we are able to match, using 9 descriptors, the predictive capacity of a method that use 20-30 times the number of descriptors.

TABLE 3
Predictive Capacity with ‘Repaired’ 2C9 Dataset

2C9 With Compounds Reclassified

| | | |
|---|---|---|
| Scheme | Normed | Ranked |
| Concordance | 95.60 | 95.10 |
| Specificity | 98.24 | 98.59 |
| Sensitivity | 80.67 | 75.33 |
| λ | 0.82 | 0.81 |

Terms are defined in Table 2.

However, if the same exercise for 2D6 is repeated, 5 compounds are predicted to be false negatives; benidipine, biperiden, manidipine, norfluoxetene, and propafenone but all of these compounds appear to be correctly reported in the database. It is not clear whether this reflects a problem with the present 2D6 model, or that the dataset is better for 2D6 than for 2C9. Given the problems constructing a good dataset for 3A4, this exercise was not done for the 3A4 dataset.

In conclusion, novel line-walking-recursive-partitioning (LWRP) embodiments are herein disclosed, which use a minimum basis set to predict if a molecule is an inhibitor, or not, for a given P450 enzyme. Given the nature of the dataset used, the prediction are reasonable accurate. It compares favorably with the SVM models of Yap and Chen¹, using 1/10 to 1/20 the number of descriptors, while having the potential for guiding drug design efforts. The present inventive embodiments are general, broadly applicable methods that allow for the use of a small basis set for partitioning molecules of diverse structure, etc.

Computer and On-Line Applications of the Present Invention

The present invention further provides a computer apparatus for implementation of the methods, comprising: (a) a computer comprising a processor and a storage device connected to the processor; (b) one or more data sets/databases stored on the storage device; and (c) a program stored on the storage device for controlling the processor. Users do not have an intelligent, fast and reliable method for evaluating and/or predicting enzyme-substrate interaction, reactivity and binding, including but not limited to predicting the likelihood of a substrate binding to a particular enzyme or class of enzymes, and to drug design, or for assessing regioselective reactivity (e.g., reactivity of particular sites or atomic positions of a molecular structure, such as a ring structure or radical moiety, application to stock purchase decisions or investment allocation decisions, application for insurance risk assessment, applications for medical treatment decisions, etc.

The present invention addresses this need by creating a software program able to creatively emulate these implementations online and link the user to specific information and services. A consume/user can access the Internet using a computer or electronic hand-held device. The software program of the present invention is usable in a stand-alone computer system.

The apparatus of the present invention is a computer, or computer network comprising a server, at least one user subsystem connected to the server via a network connecting means (e.g., user modem). Although referred to as a modem, the user modem can be any other communication means that enables network communication, for example, ethernet links. The modem can be connected to the server by a variety of connecting means, including public telephone land lines, dedicated data lines, cellular links, microwave links, or satellite communication.

The server is essentially a high-capacity, high-speed computer that includes a processing unit connected to one or more relatable data bases, comprising, for example expert-generated molecular descriptors, interaction responses, numerical descriptor-molecule values, etc. Additional databases are optionally added to the server. Also connected to the processing unit is sufficient memory and appropriate communication hardware. The communication hardware may be modems, ethernet connections, or any other suitable communication hardware. Although the server can be a single computer having a single processing unit, it is also possible that the server could be spread over several networked computers, each having its processor and having one or more databases resident thereon.

In addition to the elements described above, the server further comprises an operating system and communication software allowing the server to communicate with other computers. Various operating systems and communication software may be employed. For example, the operating system may be Microsoft Windows NT™, and the communication software Microsoft IIS™ (Internet Information Server) server with associated programs.

The databases on the server contain the information necessary to make the apparatus and process work. The databases are relatable , and may be assembled and accessed using any commercially available database software, such as Microsoft Access™, Oracle™, Microsoft SQL™ Version 6.5, etc.

A user subsystems generally includes a processor attached to storage unit, a communication controller, and a display controller. The display controller runs a display unit through which the user interacts with the subsystem. In essence, the user subsystem is a computer able to run software providing a means for communicating with the server. This software, for example, is an Internet web browser such as Microsoft Internet Explorer, Netscape Navigator, or other suitable Internet web browsers. The user subsystem can be a computer or hand-held electron device, such as a telephone or other device allowing for Internet access.

### EXAMPLE 4

### Exemplary Implementation of the Inventive Method of Line Walking using Specific Descriptors and a Training Set for Regioselective Reactivity

In particular aspects, site selective reactivity is evaluated through the use of descriptors most relevant to particular bond properties; posing the binary question of: will a particular site on a particular molecule display reactivity when exposed to a particular environment? In such implementations, descriptors and training data are employed that are appropriate for the question (e.g. known responses of different molecular types upon exposure to the environment of interest). A limited set of potential descriptors includes: Bond distances, atom hybridization, distance to heteroatoms, pH, bond polarizability, local geometry.

A recursive partitioning method for evaluating a test molecule for regioselective reactivity, comprising: establishing a set of molecular descriptors relevant for evaluating reactive sites within the molecule, the number of descriptors in the set equal to m; establishing a training set of molecules, each molecule having a known reactivity response upon exposure to a defined environment; evaluating, for each descriptor, each reactive site in the training set to provide a respective set of numerical descriptor-reactive site values for each descriptor; mapping each reactive site in the training set to respective column vectors by either: normalizing the respective descriptor values of each reactive site by scaling and translation; or by assigning, within each respective set of descriptor-reactive site values and based on the relative magnitude of the descriptor-reactive site values, a descriptor-reactive site rank value for each reactive site to provide a respective ranked set of reactive sites for each descriptor and centering the rank values (e.g., at zero), wherein each reactive site is mapped into m-dimensional space as the respective column vector to provide an m-dimensional space comprising a training set of column vectors; and recursively partitioning the training set of column vectors (i.e., the reactive sites of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test molecule for reactivity response upon exposure to a defined environment.

### EXAMPLE 5

### Method of Line Walking was Illustrated with Specific Descriptors and Training Set for Stock Purchase Decisions

The decision to purchase a particular stock is evaluated through the use of descriptors most relevant to the prediction of the future stock value. Posing the binary question of: Should I purchase a particular stock? One can employ descriptors and training data appropriate for the question (e.g. known changes in stock price given the financial variables prior to said changes). A limited set of potential descriptors includes: R&D Spending, Earnings per share (EPS), Price/earnings (P/E) ratio, Return on equity (ROE), Price-to-book value, Price-to-cash-flow ratio, Price-to-sales ratio, Payout ratio, PEG ratio.

A recursive partitioning method for evaluating a stock, comprising: establishing a set of financial descriptors relevant for evaluating stock in a company, the number of descriptors in the set equal to m; establishing a training set of stocks, each stock having a known value response; evaluating, for each descriptor, each stock in the training set to provide a respective set of numerical descriptor-stock values for each descriptor; mapping each stock in the training set to respective column vectors by either: normalizing the respective descriptor values of each reactive site by scaling and translation; or by assigning, within each respective set of descriptor-stock values and based on the relative magnitude of the descriptor-stock values, a descriptor-stock site rank value for each stock to provide a respective ranked set of stocks for each descriptor and centering the rank values (e.g., at zero), wherein each stock is mapped into m-dimensional space as the respective column vector to provide an m-dimensional space comprising a training set of column vectors; and recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test stock for value response.

### EXAMPLE 6

### Method of Line Walking was Illustrated with Specific Descriptors and Training Set for Insurance Risk Assessment

The decision to grant an insurance policy is evaluated through the use of descriptors most relevant to the risks associated with the asset and policy holder. A particular example, relates to the assessment of risk for a homeowners policy. Posing the binary question of: Should I insure a particular home? One may employ descriptors and training data appropriate for the question (e.g. known profit/loss data for Claimants/Clients). A limited set of potential descriptors includes: Geography, Population Density, Storm Frequency, Storm intensity, Emergency readiness, Home age, Homeowner credit, Home condition, Property value

A recursive partitioning method for evaluating insurance risk for a particular home/homeowner, comprising: establishing a set of risk descriptors relevant for evaluating a client, the number of descriptors in the set equal to m; establishing a training set of risks, each risk having a known loss probability; evaluating, for each descriptor, each risk in the training set to provide a respective set of numerical descriptor-risk values for each descriptor; mapping each risk in the training set to respective column vectors by either: normalizing the respective descriptor values of each client by scaling and translation; or by assigning, within each respective set of descriptor risk values and based on the relative magnitude of the descriptor-risk values, a descriptor-risk rank value for each risk to provide a respective ranked set of risks for each descriptor and centering the rank values (e.g., at zero), wherein each risk is mapped into m-dimensional space as the respective column vector to provide an m-dimensional space comprising a training set of column vectors; and recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test home/homeowner.

### EXAMPLE 7

### Method of Line Walking was Illustrated with Specific Descriptors and Training Set for Medical Treatment Decisions

The decision to initiate a medical procedure is evaluated through the use of descriptors most relevant to the probability of a positive outcome for the patient. Posing the binary question of: Should a particular procedure be employed for a particular patient? One may employ descriptors and training data appropriate for the question (e.g. known outcomes for patients). A limited set of potential descriptors includes: Age, Sex, Race, Other medications, Severity of injury/disease state, immune system strength, physical fitness

A recursive partitioning method for medical treatment decisions for a particular patient, comprising: establishing a set of patient descriptors relevant for evaluating a treatment decision, the number of descriptors in the set equal to m; establishing a training set of patients, each having a known treatment outcome; evaluating, for each descriptor, each patient in the training set to provide a respective set of numerical descriptor-patient values for each descriptor; mapping each patient in the training set to respective column vectors by either: normalizing the respective descriptor values of each patient by scaling and translation; or by assigning, within each respective set of descriptor-patient values and based on the relative magnitude of the descriptor-patient values, a descriptor-patient rank value for each patient to provide a respective ranked set of patients for each descriptor and centering the rank values (e.g., at zero), wherein each patient is mapped into m-dimensional space as the respective column vector to provide an m-dimensional space comprising a training set of column vectors; and recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a treatment decision.

### REFERENCES CITED

(1) Yap, C. W., Chen, Y. Z. Prediction of Cytochrome P450 3A4, 2D6, and 2C9 Inhibitors and Substrates by Using Support Vector Machines. J. Chem. Inf. Model. 2005, 45, 982-992.
(2) Pharmaceutical Industry 2001 Profile. In Pharmaceutical Manufacturers of America: Washington DC, 2001.
(3) O'Brien, S. E.; de Groot, M. J. Greater than the sum of its parts: combining models for useful ADMET prediction. J. Med. Chem. 2005, 48, 1287-1291.
(4) Korzekwa, K. R.; Jones, J. P. Predicting the cytochrome P450 mediated metabolism of xenobiotics. [Review]. Pharmacogenetics 1993, 3, 1-18.
(5) Jones, J. P.; Mysinger, M.; Korzekwa, K. R. Computational models for cytochrome P450: a predictive electronic model for aromatic oxidation and hydrogen atom abstraction. Drug Metab. Dispos. 2002, 30, 7-12.
(6) Ekins, S.; De Groot, M. J.; Jones, J. P. Pharmacophore and three-dimensional quantitative structure activity relationship methods for modeling cytochrome P450 active sites. Drug Metab. Dispos. 2001, 29, 936-944.
(7) Yoshida, F.; Topliss, J. G. QSAR model for drug human oral bioavailability. J. Med. Chem. 2000, 43, 2575-2585.
(8) Sorich, M. J.; Miners, J. O.; McKinnon, R. A.; Winkler, D. A.; Burden, F. R. et al. Comparison of linear and nonlinear classification algorithms for the prediction of drug and chemical metabolism by human UDP-glucuronosyltransferase isoforms. J. Chem. Inf. Comput. Sci. 2003, 43, 2019-2024.
(9) Susnow, R. G.; Dixon, S. L. Use of robust classification techniques for the prediction of human cytochrome P450 2D6 inhibition. J. Chem. Inf. Comput. Sci. 2003, 43, 1308-1315.
(10) Chohan, K. K.; Paine, S. W.; Mistry, J.; Barton, P.; Davis, A. M. A rapid computational filter for cytochrome P450 1A2 inhibition potential of compound libraries. J. Med. Chem. 2005, 48, 5154-5161.
(11) Ekins, S.; Berbaum, J.; Harrison, R. K. Generation and validation of rapid computational filters for CYP2D6 and CYP3A4. Drug Metab. Dispos. 2003, 31, 1077-1080.
(12) Matthews, B. W. Comparison of the predicted and observed secondary structure of T4 phage lysozyme. Biochim Biophys Acta 1975, 405, 442-451.
(13) Korzekwa, K. R.; Krishnamachary, N.; Shou, M.; Ogai, A.; Parise, R. A. et al. Evaluation of atypical cytochrome P450 kinetics with two-substrate models: evidence that multiple substrates can simultaneously bind to cytochrome P450 active sites. Biochemistry 1998, 37, 4137-4147.
(14) Hutzler, J. M.; Tracy, T. S. Atypical kinetic profiles in drug metabolism reactions. Drug Metab. Dispos. 2002, 30, 355-362.
(15) Locuson, C. W.; Rock, D. A.; Jones, J. P. Quantitative binding models for CYP2C9 based on benzbromarone analogues. Biochemistry 2004, 43, 6948-6958.
(16) Jones, J. P.; He, M. X.; Trager, W. F.; Rettie, A. E. Three-Dimensional Quantitative Structure-Activity Relationship For Inhibitors Of Cytochrome P4502c9. Drug Metab. Disp. 1996, 24, 1-6.
(17) Arimoto, R.; Prasad, M. A.; Gifford, E. M. Development of CYP3A4 inhibition models: Comparisons of machine-learning techniques and molecular descriptors. J. Biomol. Screening 2005, 10, 197-205.
(18) Haining, R. L.; Jones, J. P.; Henne, K. R.; Fisher, M. B.; Koop, D. R. et al. Enzymatic determinants of the substrate specificity of CYP2C9: role of B′—C loop residues in providing the pi-stacking anchor site for warfarin binding. Biochemistry 1999, 38, 3285-3292.
(19) Ayub, M.; Levell, M. J. The Inhibition of Human Prostatic Aromatase-Activity by Imidazole Drugs Including Ketoconazole and 4-Hydroxyandrostenedione. Biochem. Pharmacol. 1990, 40, 1569-1575.
(20) Rao, S.; Aoyama, R.; Schrag, M.; Trager, W. F.; Rettie, A. et al. A refined 3-dimensional QSAR of cytochrome P450 2C9: computational predictions of drug interactions. J. Med. Chem. 2000, 43, 2789-2796.
(21) Venkatakrishnan, K.; von Moltke, L. L.; Greenblatt, D. J. Effects of the antifungal agents on oxidative drug metabolism—Clinical relevance. Clin. Pharmacokinet. 2000, 38, 111-180.
(22) Weemhoff, J. L.; von Moltke, L. L.; Richert, C.; Hesse, L. M.; Harmatz, J. S. et al. Apparent mechanism-based inhibition of human CYP3A in-vitro by lopinavir. J. Pharm. Pharmacol. 2003, 55, 381-386.
(23) Kirchheiner, J.; Roots, I.; Goldammer, M.; Rosenkranz, B.; Brockmoller, J. Effect of Genetic Polymorphisms in Cytochrome P450 (CYP) 2C9 and CYP2C8 on the Pharmacokinetics of Oral Antidiabetic Drugs: Clinical Relevance. Clin Pharmacokinet 2005, 44, 1209-1225.
(24) Komatsu, K.; Ito, K.; Nakajima, Y.; Kanamitsu, S.; Imaoka, S. et al. Prediction of in vivo drug-drug interactions between tolbutamide and various sulfonamides in humans based on in vitro experiments. Drug Metab. Dispos. 2000, 28, 475-481.

1. A recursive partitioning method for evaluating, by a user, a test molecule for a molecular interaction, comprising:
establishing a set of molecular descriptors relevant for evaluating a molecular interaction, the number of descriptors in the set equal to m;
establishing a training set of molecules, each molecule having a known interaction response for the molecular interaction, and wherein the training set comprises at least one member demonstrating the molecular interaction and at least one member not demonstrating the molecular interaction;
evaluating, for each descriptor, each molecule in the training set to provide a respective set of numerical descriptor-molecule values for each descriptor;
mapping each molecule in the training set to respective column vectors by either: normalizing the respective descriptor values of each molecule by scaling and translation, or by assigning, within each respective set of descriptor-molecule values and based on the relative magnitude of the descriptor-molecule values, a descriptor-molecule rank value for each molecule to provide a respective ranked set of molecules for each descriptor and centering the rank values (e.g., at zero), wherein each molecule is mapped into m-dimensional space as the respective column vector to provide an m-dimensional space comprising a training set of column vectors;
recursively partitioning the training set of column vectors (i.e., the molecules of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test molecule for a molecular interaction; and
providing the evaluation to a user of the method.

2. The recursive partitioning method of claim 1, wherein the number of descriptors m is a number in a range of about 5 to about 20, about 7 to about 15, about 8 to about 12, about 9 to about 11, 9 to 11, or 9 to 10.

3. The recursive partitioning method of claim 2, wherein the number of descriptors m is 9 or 10.

4. The recursive partitioning method of claim 1, further comprising:
selecting a test molecule;
determining a test ranking vector (ranking column vector) for the test molecule by assigning, with respect to each descriptor, a test rank value to the test molecule, wherein the assigned test rank value: is that of a training set molecule having a matching descriptor-molecule value; is a test rank value that is a mean rank value where the test descriptor-molecule value lies between those of two training set molecules; is a rank that is one rank higher than the maximum rank of the training set; or is one rank lower than the minimum rank of the training set, to provide for a test ranking vector mapped within the m-dimensional array; and
evaluating the test molecule (test ranking vector) by application of the decision tree having interior nodes corresponding to LWRP-selected hyperplanes, wherein evaluating a test molecule for the molecular interaction is, at least in part, afforded.

5. The recursive partitioning method of claim 4, wherein the test molecule is outside the training set of molecules.

6. The recursive partitioning method of claim 4, wherein the molecular interaction is enzyme-substrate binding or interaction, protein-protein interaction or docking, protein-small molecule interactions, protein-nucleotide interactions, molecule-molecule interactions, surface-molecule interactions, protein activity inhibition or activation based on a molecular interaction or binding event, or modulation or inhibition of P450 drug metabolism.

7. A method for predicting a numerical value for a molecule, comprising:
constructing a series of decision trees based on a training set of molecules, each tree generated according the method of claim 1 and each tree associated with a specific molecular concentration;
tracking the designation of each molecule in the training set to provide a respective set of threshold concentrations, corresponding in each case to the concentration at which the respective molecule changes designation from one that does not demonstrate the molecular interaction to one that does, or vice versa, to provide for evaluation of the relative affinity (pKi) of a molecule to that of a specific interaction partner of interest.

8. The method of claim 7, wherein a numerical value (pKi) for a test molecule is determined by application of LWRP as described herein.

9. The method of claim 1, wherein the method is at least in part implemented on a computer.

10. The method of claim 9, comprising implementing at least one of evaluating, mapping and recursively partitioning on a computer.

11. The method of claim 9, comprising implementation of at least a part of the method over a wide-area network and/or local area network.

12. A recursive partitioning method for evaluating a test molecule for regioselective reactivity, comprising:
establishing a set of molecular descriptors relevant for evaluating reactive sites or atomic positions within a molecule, the number of descriptors in the set equal to m;
establishing a training set of molecules, each molecule having a known reactivity response upon exposure to a defined environment;
evaluating, for each descriptor, each reactive site in the training set to provide at least one respective set of numerical descriptor-reactive site values for each descriptor;
mapping each reactive site in the training set to respective column vectors by either: normalizing the respective descriptor values of each reactive site by scaling and translation, or by assigning, within each respective set of descriptor-reactive site values and based on the relative magnitude of the descriptor-reactive site values, a descriptor-reactive site rank value for each reactive site to provide a respective ranked set of reactive sites for each descriptor and centering the rank values (e.g., at zero), wherein each reactive site is mapped into m-dimensional space as the respective column vector to provide an m-dimensional space comprising a training set of column vectors;
recursively partitioning the training set of column vectors (i.e., the reactive sites of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test molecule for reactivity response upon exposure to a defined environment; and
providing the evaluation to a user of the method.

13. The recursive partitioning method of claim 12, wherein the number of descriptors m is a number in a range of about 5 to about 20, about 7 to about 15, about 8 to about 12, about 9 to about 11, 9 to 11, or 9 to 10.

14. The recursive partitioning method of claim 13, wherein the number of descriptors m is 9 or 10.

15. The recursive partitioning method of claim 12, further comprising:
selecting a test molecule;
determining a test ranking vector (ranking column vector) for the test molecule by assigning, with respect to each descriptor, a test rank value to the test molecule, wherein the assigned test rank value: is that of a training set molecule having a matching descriptor-molecule value; is a test rank value that is a mean rank value where the test descriptor-molecule value lies between those of two training set molecules; is a rank that is one rank higher than the maximum rank of the training set; or is one rank lower than the minimum rank of the training set, to provide for a test ranking vector mapped within the m-dimensional array; and
evaluating the test molecule (test ranking vector) by application of the decision tree having interior nodes corresponding to LWRP-selected hyperplanes, wherein evaluating a test molecule for reactivity response upon exposure to a defined environment is, at least in part, afforded.

16. A recursive partitioning method for evaluating a stock, comprising:
establishing a set of financial descriptors relevant for evaluating stock in a company, the number of descriptors in the set equal to m;
establishing a training set of stocks, each stock having a known value response;
evaluating, for each descriptor, each stock in the training set to provide a respective set of numerical descriptor-stock values for each descriptor;
mapping each stock in the training set to respective column vectors by either: normalizing the respective descriptor values of each reactive site by scaling and translation; or by assigning, within each respective set of descriptor-stock values and based on the relative magnitude of the descriptor-stock values, a descriptor-stock site rank value for each stock to provide a respective ranked set of stocks for each descriptor and centering the rank values (e.g., at zero), wherein each stock is mapped into m-dimensional space as the respective column vector to provide an m-dimensional space comprising a training set of column vectors;
recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test stock for value response; and
providing the evaluation to a user of the method.

17. The recursive partitioning method of claim 16, wherein the number of descriptors m is a number in a range of about 5 to about 20, about 7 to about 15, about 8 to about 12, about 9 to about 11, 9 to 11, or 9 to 10.

18. The recursive partitioning method of claim 17, wherein the number of descriptors m is 9 or 10.

19. The recursive partitioning method of claim 16, further comprising:
selecting a test stock;
determining a test ranking vector (ranking column vector) for the test stock by assigning, with respect to each descriptor, a test rank value to the test stock, wherein the assigned test rank value: is that of a training set stock having a matching descriptor-stock value; is a test rank value that is a mean rank value where the test descriptor-stock value lies between those of two training set stocks; is a rank that is one rank higher than the maximum rank of the training set; or is one rank lower than the minimum rank of the training set, to provide for a test ranking vector mapped within the m-dimensional array; and
evaluating the test stock (test ranking vector) by application of the decision tree having interior nodes corresponding to LWRP-selected hyperplanes, wherein evaluating a test stock for value response, at least in part, afforded.

20. A recursive partitioning method for evaluating insurance risk for a particular property/property owner/client, comprising:
establishing a set of risk descriptors relevant for evaluating a client, the number of descriptors in the set equal to m;
establishing a training set of risks, each risk having a known loss probability;
evaluating, for each descriptor, each risk in the training set to provide a respective set of numerical descriptor-risk values for each descriptor;
mapping each risk in the training set to respective column vectors by either: normalizing the respective descriptor values of each risk by scaling and translation; or by assigning, within each respective set of descriptor risk values and based on the relative magnitude of the descriptor-risk values, a descriptor-risk rank value for each risk to provide a respective ranked set of risks for each descriptor and centering the rank values (e.g., at zero), wherein each risk is mapped into m-dimensional space as the respective column vector to provide an m-dimensional space comprising a training set of column vectors;
recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test property/property owner/client; and
providing the evaluation to a user of the method.

21. The recursive partitioning method of claim 20, wherein the number of descriptors m is a number in a range of about 5 to about 20, about 7 to about 15, about 8 to about 12, about 9 to about 11, 9 to 11, or 9 to 10.

22. The recursive partitioning method of claim 21, wherein the number of descriptors m is 9 or 10.

23. The recursive partitioning method of claim 20, further comprising:
selecting a test insurance risk;
determining a test ranking vector (ranking column vector) for the test insurance risk by assigning, with respect to each descriptor, a test rank value to the test insurance risk, wherein the assigned test rank value: is that of a training set insurance risk having a matching descriptor-insurance risk value; is a test rank value that is a mean rank value where the test descriptor-insurance risk value lies between those of two training set insurance risk; is a rank that is one rank higher than the maximum rank of the training set; or is one rank lower than the minimum rank of the training set, to provide for a test ranking vector mapped within the m-dimensional array; and
evaluating the test insurance risk (test ranking vector) by application of the decision tree having interior nodes corresponding to LWRP-selected hyperplanes, wherein evaluating a test insurance risk is, at least in part, afforded.

24. A recursive partitioning method for medical treatment decisions for a particular patient, comprising:
establishing a set of patient descriptors relevant for evaluating a treatment decision, the number of descriptors in the set equal to m;
establishing a training set of patients, each having a known treatment outcome;
evaluating, for each descriptor, each patient in the training set to provide a respective set of numerical descriptor-patient values for each descriptor;
mapping each patient in the training set to respective column vectors by either: normalizing the respective descriptor values of each patient by scaling and translation; or by assigning, within each respective set of descriptor-patient values and based on the relative magnitude of the descriptor-patient values, a descriptor-patient rank value for each patient to provide a respective ranked set of patients for each descriptor and centering the rank values (e.g., at zero), wherein each patient is mapped into m-dimensional space as the respective column vector to provide an m-dimensional space comprising a training set of column vectors;
recursively partitioning the training set of column vectors (i.e., the stocks of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a treatment decision; and
providing the evaluation to a user of the method.

25. The recursive partitioning method of claim 24, wherein the number of descriptors m is a number in a range of about 5 to about 20, about 7 to about 15, about 8 to about 12, about 9 to about 11, 9 to 11, or 9 to 10.

26. The recursive partitioning method of claim 25, wherein the number of descriptors m is 9 or 10.

27. The recursive partitioning method of claim 24, further comprising:
selecting a test patient;
determining a test ranking vector (ranking column vector) for the test patient by assigning, with respect to each descriptor, a test rank value to the test patient, wherein the assigned test rank value: is that of a training set patient having a matching descriptor-patient value; is a test rank value that is a mean rank value where the test descriptor patient value lies between those of two training set patients; is a rank that is one rank higher than the maximum rank of the training set; or is one rank lower than the minimum rank of the training set, to provide for a test ranking vector mapped within the m-dimensional array; and
evaluating the test patient (test ranking vector) by application of the decision tree having interior nodes corresponding to LWRP-selected hyperplanes, wherein evaluating a test patient is, at least in part, afforded.

28. A computer apparatus for evaluating a question relating to a test object, comprising:
(a) a computer comprising a processor and a storage device connected to the processor;
(b) an object descriptor set database stored on the storage device, wherein the object descriptor set database comprises a plurality object descriptors;
(c) a training set database stored on the storage device, wherein the training set database comprises plurality of training objects;
(d) a data set of descriptor-object values derived from evaluation of the object descriptor set and the training dataset;
(e) a program stored on the storage device for controlling the processor, wherein the program is operative with the processor to (i) map each object in the training set to respective column vectors by either: normalizing the respective descriptor values of each object by scaling and translation, or by assigning, within each respective set of descriptor-object values and based on the relative magnitude of the descriptor-object values, a descriptor-object rank value for each object to provide a respective ranked set of objects for each descriptor and centering the rank values (e.g., at zero), wherein each object is mapped into m-dimensional space as the respective column vector to provide an m-dimensional space comprising a training set of column vectors; and (j) recursively partitioning the training set of column vectors (i.e., the objects of the m-dimensional space) according to splitting hyperplanes (that incorporate information from all descriptors simultaneously) that are generated according to a line walking algorithm (LWRP) as described herein, to provide for a decision tree having interior nodes corresponding to LWRP selected hyperplanes, the tree suitable for evaluating a test object for an object interaction; and
providing the evaluation to a user.

29. The apparatus of claim 28, further comprising a user database stored on the storage device, wherein the program is operative with the processor to store user information in the user database, and update user information when new user information is received.

30. The apparatus of claim 29, wherein the program is further operative with the processor to track user information.

31. A software program, stored on a reproducible medium, computer or database, comprising code suitable for application of one or more decision trees having interior nodes corresponding to LWRP-selected hyperplanes for executing the methods of any one of claims 1, 7, 12, 16, 20 and 24.

32. A software program, stored on a reproducible medium, computer or database, comprising code suitable for application of one or more decision trees having interior nodes corresponding to LWRP-selected hyperplanes as described herein.

33. The apparatus of claim 28, wherein the test object is selected from the group consisting of molecular interaction, regioselectivity to site reactivity, or stock valuation, insurance risk, and medical diagnosis or treatment.
